(19) United States
(12) Patent Application Publication
(10) Pub. No.: US 2004/0096023 A1
(43) Pub. Date: May 20, 2004

(54) Reduced phase error derotator system and method

(76) Inventor: Richard Bourdeau, St. Laurent (CA)

Correspondence Address: MARK C. COMTOIS, Duane Morris LLP, 1667 K Street, N.W., Suite 700, Washington, DC, 20006, US

(21) Appl. No.: 10/298,902

(22) Filed: Nov. 19, 2002

(51) Int. Cl. H04L 7/04

(52) U.S. Cl. 375/362

(57) ABSTRACT

A reduced phase error derotator (100) includes a novel phase accumulator (12), which provides an output signal (38) having a value which approaches zero when the value of the phase accumulator input signal (34) is zero. This is particularly advantageous in situations wherein a sudden phase transient appears at the input of the phase accumulator (12) causing the phase accumulator input signal (34) to become nonzero, the phase accumulator (12) will quickly react to this transient, resulting in the value of the phase accumulator output signal (38) to be nonzero. When the transient at the input to the phase accumulator (12) disappears and the value of the phase accumulator input signal (34) returns to zero, the phase accumulator (12) will quickly react to this change resulting in the value of the phase accumulator output signal (38) becoming zero. Furthermore, in demodulators having components coupled to the derotator (100), this derotator (100) alleviates the need for these components to compensate for phase differences between signals coupled to these components and the phase accumulator output signal (38).

### BACKGROUND

The field of the present invention is generally related to demodulators and more specifically related to reducing phase error in demodulators derotators.

The transmission and reception of information via modulation/demodulation schemes such as quadrature amplitude modulation (QAM), phase shift keying (PSK), and frequency shift keying (FSK) are continuing to increase in use. Typically, information is modulated (via modulators) in accordance with a specific modulation scheme, transmitted (via transmitters), received (via receivers), and demodulated (via demodulators) in accordance with a corresponding demodulation scheme. It is not uncommon for the transmitted signal to be distorted prior to reception. This distortion is often in the form of frequency and phase error observed by the receiver. In modulation schemes such as QAM, this phase error may be seen as rotating a plot of the constellation of the information. Many demodulators include derotators for compensating for this phase error, and thus derotating the constellation plot.

Standard derotators have disadvantages. A typically derotator attempts to compensate for phase error by tracking the phase error and providing a signal that has a compensating phase error. However, when a standard derotator provides a steady state output signal, a phase error is present at its input. This disadvantageously produces phase errors between various signals within the demodulator. Any circuit or component that is located in front of the derotator (e.g., a slope equalizer, a DC offset compensation circuit, a gain compensation circuit, a clock recovery circuit, an equalizer circuit, or a combination thereof) will receive signals having phase error, yet the output of the derotator will not exhibit the phase error. Thus, these demodulator circuits/components must compensate for the phase error, for example, by more complex circuitry, more costly circuitry, less compact circuitry, circuits operating independent of the phase of the provided signals, or a combination thereof.

A derotator which reduces the above described phase errors is desired.

In one embodiment, a derotator phase accumulator circuit includes a phase accumulator adder configured to receive a phase accumulator input signal. The phase accumulator adder is coupled to a phase accumulator register and a phase accumulator gain portion. The phase accumulator register is configured to provide a phase accumulator output signal. The phase accumulator register is coupled to the phase accumulator adder and the phase accumulator gain portion. The phase accumulator gain portion is coupled to the phase accumulator adder and the phase accumulator register. A gain value of the phase accumulator gain portion is less than one.

In another embodiment, a derotator includes a phase accumulator. The phase accumulator is configured to receive an accumulator input signal and provide an accumulator output signal. A value of the accumulator output signal approaches zero in response to a value of the accumulator input signal being approximately equal to zero.

In yet another embodiment, a method for reducing phase error in a derotator having a phase accumulator includes summing a phase accumulator input signal and a phase accumulator gain signal, generating a phase accumulator feedback signal indicative of a phase accumulator output signal, generating the phase accumulator gain signal, and providing the phase accumulator output signal. A value of the phase accumulator gain signal is approximately equal to a product of a gain value and a value of the phase accumulator feedback signal, wherein the gain value is less than one. Also a value of the phase accumulator output signal approaches zero in response to a value of the phase accumulator input signal being approximately equal to zero.

### BRIEF DESCRIPTION OF THE DRAWINGS

In the figures:

FIG. 1 is a functional block diagram of a demodulator in accordance with an embodiment of the present invention;

FIG. 2A is a graphical plot depicting a QAM constellation without phase error;

FIG. 2B is a graphical plot depicting a QAM constellation with phase error;

FIG. 3 is a functional block of a derotator in accordance with an embodiment of the present invention;

FIG. 4 is a functional block diagram of a derotator phase accumulator in accordance with an embodiment of the present invention;

FIG. 5 is a functional block diagram of a demodulator illustrating a variety of demodulator components and relative phase differences in accordance with an embodiment of the present invention; and

FIG. 6 is a flow diagram of a process for reducing phase error in accordance with an embodiment of the present invention.

### DETAILED DESCRIPTION

In accordance with an embodiment of the present invention, a reduced phase error derotator includes a novel phase accumulator. This novel phase accumulator provides an output signal having a value which tends to zero when the value of a phase accumulator input signal is zero. Thus, when the input signal of the phase accumulator is zero, even for a very short period of time, the output signal of the phase accumulator will quickly approach zero. For example, if a sudden phase transient appearing at the input of the phase accumulator causes the phase accumulator input signal to become nonzero, the phase accumulator will quickly react to this transient, resulting in the value of the phase accumulator output signal to be nonzero. When the transient at the input to the phase accumulator disappears and the value of the phase accumulator input signal returns to zero, the phase accumulator will quickly react to this change resulting in the value of the phase accumulator output signal becoming zero. This is particularly advantageous in demodulators having components (such as equalizer circuits, clock recovery circuits, DC offset compensation circuits, slope equalizer circuits, and gain compensation circuits, for example) therein. Phase difference between signals provided to the input to such components and the phase accumulator output signal are minimized during the occurrence of the aforementioned transients. Thus alleviating the need for the components to compensate for these phase differences.

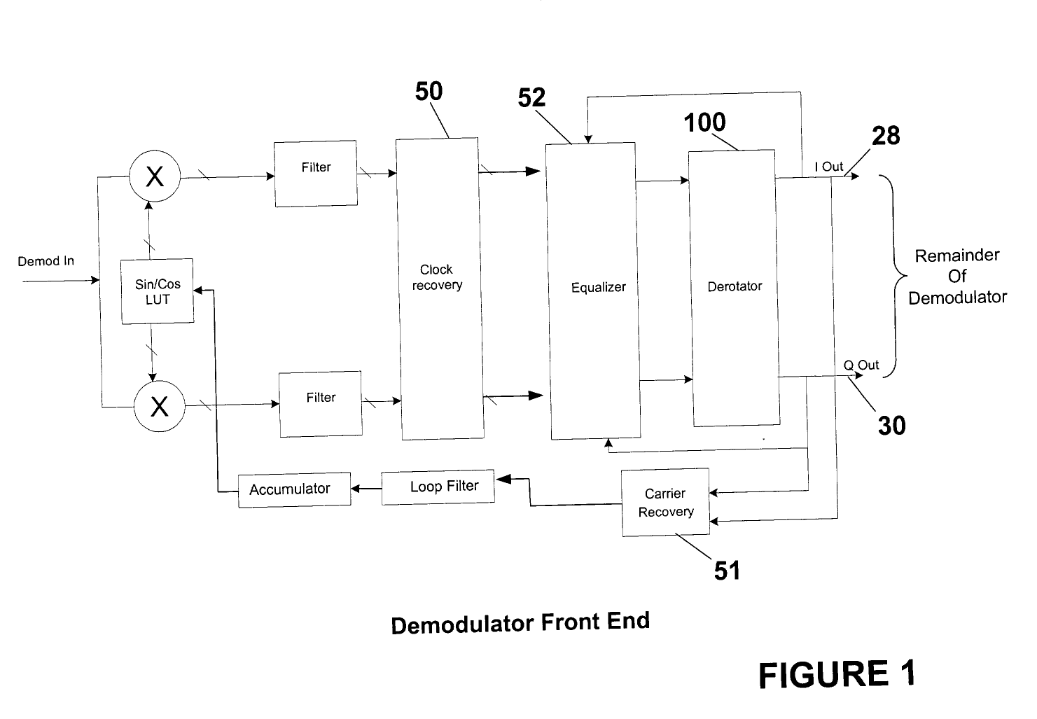

Referring now to FIG. 1, there is shown a functional block diagram of a front end portion of a demodulator comprising derotator 100 in accordance with an embodiment of the present invention. The reduced phase error derotator 100 is described herein with application to quadrature amplitude modulation (QAM), however it is to be understood that the reduced phase error derotator 100 may be used with various types of demodulators, such as, for example, those applicable to phase shift keying (PSK), frequency shift keying (FSK), as well as QAM.

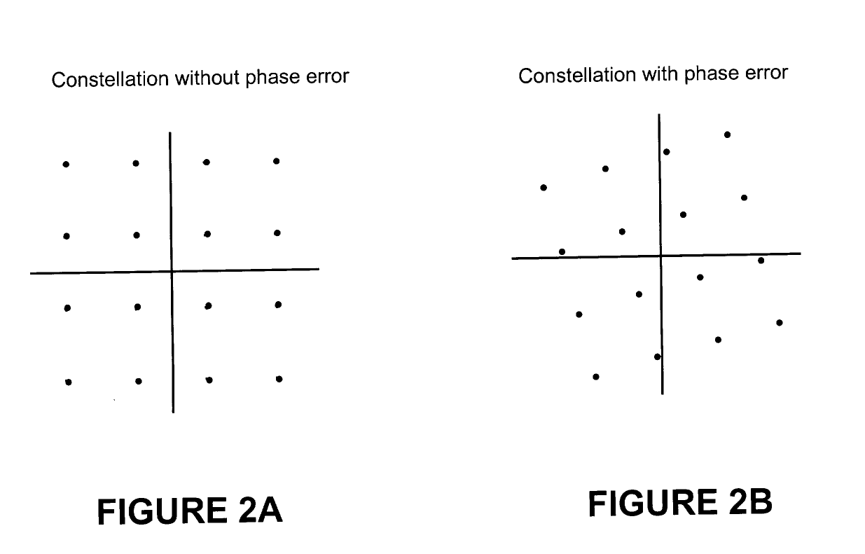

QAM is widely used for transmission and reception of signals, and therefore many aspects of QAM are not described herein in detail. QAM transmits data as a sequence of two dimensional complex symbols having in-phase (I) and quadrature (Q) components. Each symbol adopts a specific predefined value based upon the data it represents. A set of all of the values available for transmission defines a character set which forms a constellation when graphically represented on a two dimensional plot (See FIGS. 2A and 2B for example). To receive a QAM signal, an exemplary QAM demodulator, as shown in FIG. 1, performs the functions of clock recovery 50, equalization 52, and carrier recovery 5 1. Carrier recovery portion 51 creates a reference carrier for determining the frequency and phase of in-phase signal 28 indicative of the I component and quadrature phase signal 30 indicative of the Q component. Carrier recovery portion 51 is typically designed to have a large tracking range and a slow response time. Having a slow response time, typical carrier recovery can not compensate for fast acting changes in phase.

FIG. 2A and FIG. 2B are two dimensional graphical plots depicting QAM constellations without and with phase error, respectively. As shown in FIG. 2A and 2B, the constellation appears to be rotated by the phase error. The derotator 100 facilitates compensation of this rotation. The derotator 100 is designed to react quickly to changes in frequency and phase, and thus is suited to compensate for demodulator errors resulting from fast frequency and phase changes (e.g., transients).

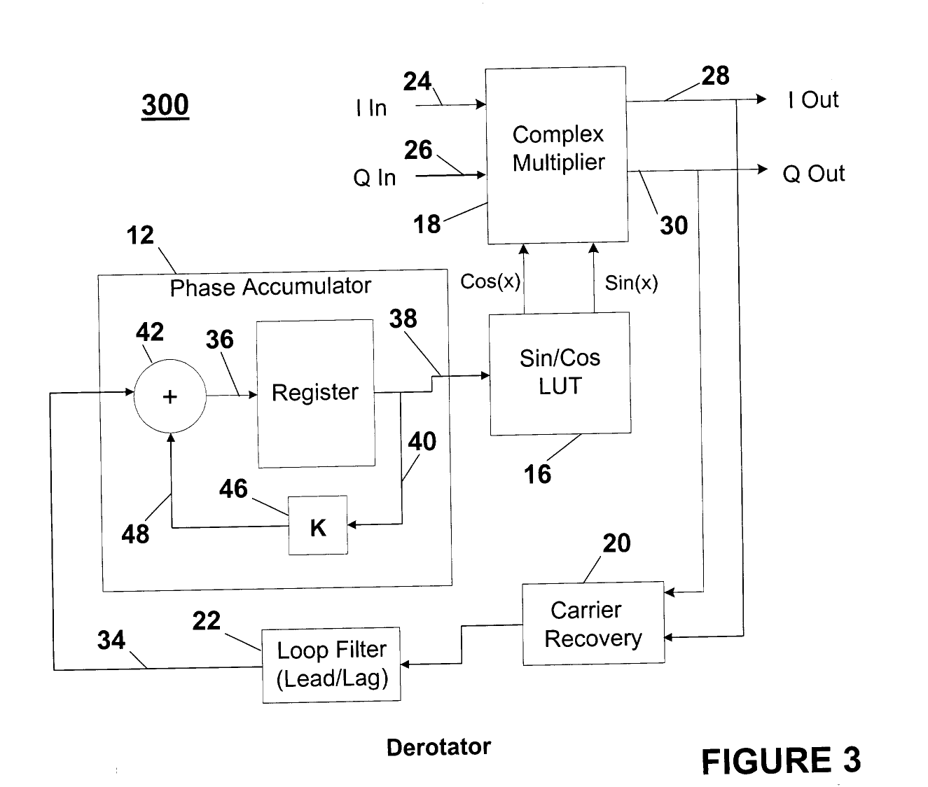

FIG. 3 is a functional block diagram of a derotator 300 comprising complex multiplier 18, Sin/Cosine look up table (Sin/Cos LUT) 16, carrier recovery portion 20, loop filter (also referred to as a lead/lag filter) 22, and phase accumulator 12, in accordance with an embodiment of the present invention. The complex multiplier 18 receives I and Q signals 24 and 26, respectively, and provides I and Q signals 28 and 30, respectively, having reduced phase error. The Sin/Cos LUT 16 provides sine and cosine signals, Sin(x) and Cos(x), respectively, to the complex multiplier 18, by which the I and Q signals 24, 26, are multiplied. The phase components of the sine and cosine signals, Sin(x) and Cos(x), are such that multiplication of same by the I and Q signals, 24, 26, and appropriate filtering provides signals 28, 30, and compensates for phase errors in the I and Q signals, 24, 26.

The I and Q signals 28, 30, are provided to the carrier recovery portion 20 and the loop filter 22. The carrier recovery portion 20 and the loop filter 22 process the I and Q signals 28, 30, to result in a DC offset signal, or digital signal, 34 (referred to herein as the phase accumulator input signal 34) which is indicative of the phase error between the desired phase and currently measured phase of each of the signals 28 and 30. The phase accumulator input signal 34 is either an up signal or a down signal. An up signal indicates that the currently measured phase leads the desired phase. A down signal indicates that the desired phase leads the currently measured phase. Thus the phase accumulator input signal 34 is steady state and approximately equal to zero when the carrier recovery portion 20 is locked (in synchronization) with the I and Q signals 28, 30.

The phase accumulator input signal 34 is provided to the phase accumulator 12. The phase accumulator 12 receives the phase accumulator input signal 34 and provides a phase accumulator output signal 38 to the Sin/Cos LUT 16, for reducing phase error in the I and Q signals 28, 30. As mentioned above, the phase accumulator 12 reacts very quickly to changes in phase/frequency thus minimizing the difference in phase, AO, between signals coupled to components, such as the clock recovery circuit 50 and the equalizer circuit 52, and the phase accumulator output signal 38.

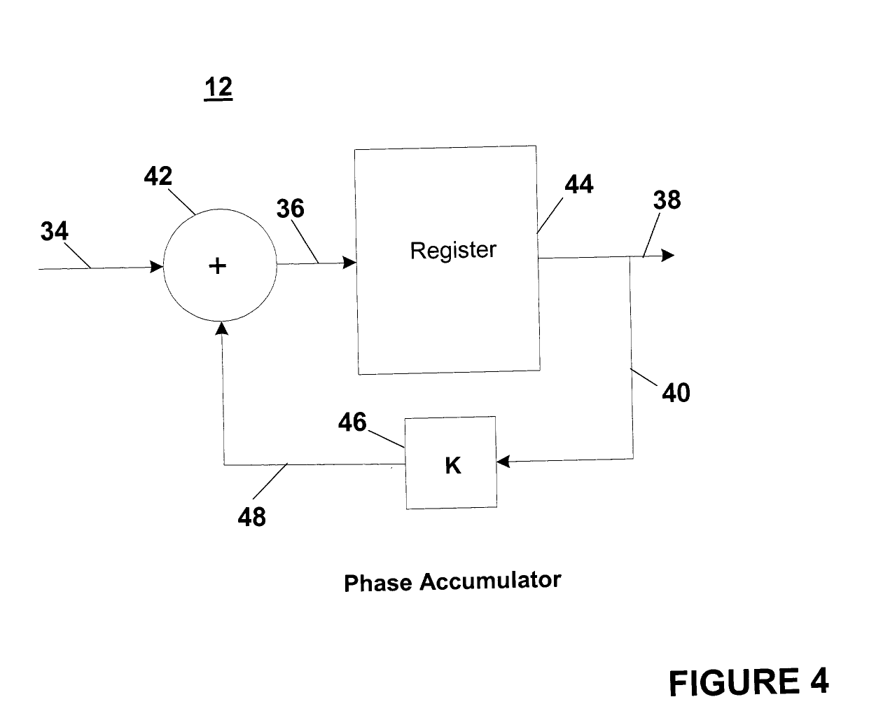

FIG. 4 is a functional block diagram of a phase accumulator 12 comprising an adder 42, a register 44, and a gain portion 46, in accordance with an embodiment of the present invention. As described in more detail below, the phase accumulator 12 provides a phase accumulator output signal 38 that does not lock onto a steady state value when the phase accumulator input signal 34 is equal to a steady state value (unless both the phase accumulator input signal 34 and the phase accumulator output signal 38 are equal to zero). This is in contrast to current phase accumulators, which provide a steady state value in response to a zero value input signal. The phase accumulator adder 42 is configured to receive the phase accumulator input signal 34 and provide phase accumulator summation signal 36. The phase accumulator adder 42 is coupled to the phase accumulator register 44 and the phase accumulator gain portion 46. The phase accumulator register 44 is configured to receive the phase accumulator summation signal 36 and provide the phase accumulator output signal 38. The phase accumulator register 44 is coupled to the phase accumulator adder 42 and the phase accumulator gain portion 46. The phase accumulator gain portion 46 is configured to receive the phase accumulator feedback signal 40 and provide the phase accumulator gain signal 48. The phase accumulator feedback 40 is indicative of the phase accumulator output signal 38. The phase accumulator gain portion 46 is coupled to the phase accumulator adder 42 and the phase accumulator register 44. The gain portion 46 is configured to multiply the value of the phase accumulator feedback signal 40 by the gain value, K. In one embodiment, K is less than one. Thus the phase accumulator gain signal 48 is indicative of the following equation.

Gs=K Fs, where (1)

Gs is indicative of the value of the phase accumulator gain signal 48, K is indicative of the gain value, being less than one, and Fs is indicative of the value of the phase accumulator feedback signal 40.

In operation, the phase accumulator adder 42 sums the value of the phase accumulator input signal 34 with the value of the phase accumulator gain signal 48. The value of this summation is provided to the phase accumulator register 44 via the phase accumulator summation signal 36. The phase accumulator register 44 stores this phase accumulator summation value and provides same via the phase accumulator output signal 38. This summation value is received by the phase accumulator gain portion 46 via the phase accumulator feedback signal 40. Because the gain value, K, is less than one, the value provided to the phase accumulator adder 42 (at the next clock cycle, for example) via the phase accumulator gain signal 48 is less than the summation value. This value is added to the current value of the phase accumulator input signal 34. When the value of the phase accumulator input signal is equal to zero, as time progresses (e.g., during successive clock cycles), the value of the phase accumulator summation signal 36 provided to the phase accumulator register 44, and thus the value of the phase accumulator output signal 38, steadily decreases until the value of the phase accumulator output signal 38 becomes approximately equal to zero. The amount of time required for the value of the phase accumulator output signal 38 to equal zero is dependent upon the speed (e.g., frequency) of the clock (not shown in FIG. 4) or other appropriate triggering means for the phase accumulator 12. Thus, the phase accumulator 12 is configured to react quickly to transients by adjusting the clock/trigger signal to the phase accumulator 12. The phase accumulator 12 will not lock onto a steady state phase error at its input. The ability of the phase accumulator 12 to quickly react to phase errors, as described above, aids in minimizing phase differences, AO, between various signals throughout the demodulator and signals provided by the derotator 100 (e.g., signals 28, 30).

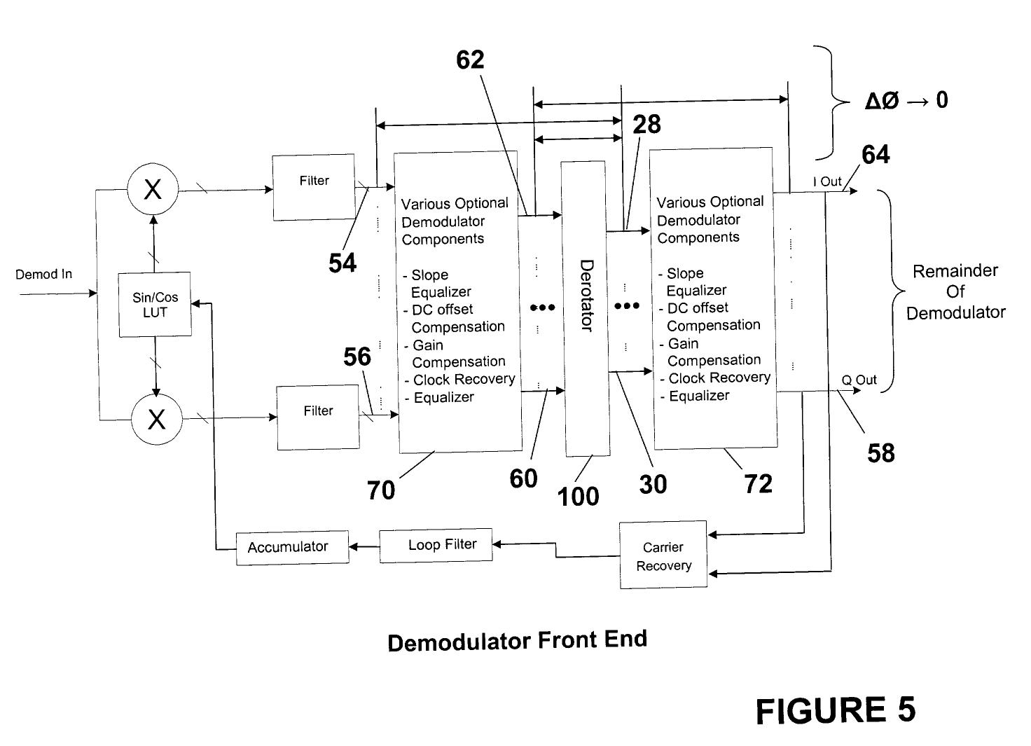

FIG. 5 is a functional block diagram of a demodulator illustrating a variety of demodulator components 70, 72, and relative phase differences between various signals in accordance with an embodiment of the present invention. As illustrated in FIG. 5 by exemplary components 70 and 72, various demodulator components may be included in the demodulator, such as a slope equalizer, a DC offset compensation circuit, a gain compensation circuit, a clock recovery circuit, an equalizer circuit, or a combination thereof, for example. Also, as depicted by exemplary components 70 and 72, these various components may be coupled, individually or in combination, to the input side of the derotator 100, to the output side of the derotator 100, or a combination thereof. Each demodulator component is configured to receive respective input signals, as depicted by exemplary signals 54 and 56 for component 70 and signals 28 and 30 for component 72. Also, each component is configured to provide respective output signals as depicted by exemplary signals 58 and 60 for component 70 and signals 62 and 64 for component 72. When the phase difference, AO, between the phase accumulator input signal 34 and the phase accumulator output signal 38 approaches zero, so does the phase difference between signals 54 and 28, 56 and 30, 60 and 30, and 62 and 28. Reducing these various phase differences, AOs, eliminates the need for the various components to compensate for phase differences. Typically, these components are designed to operate independent of the carrier phase, making them more complex and costly. Utilization of the derotator 100, allows the various components to be designed to operate dependent upon the carrier phase, thus being less complex and costly.

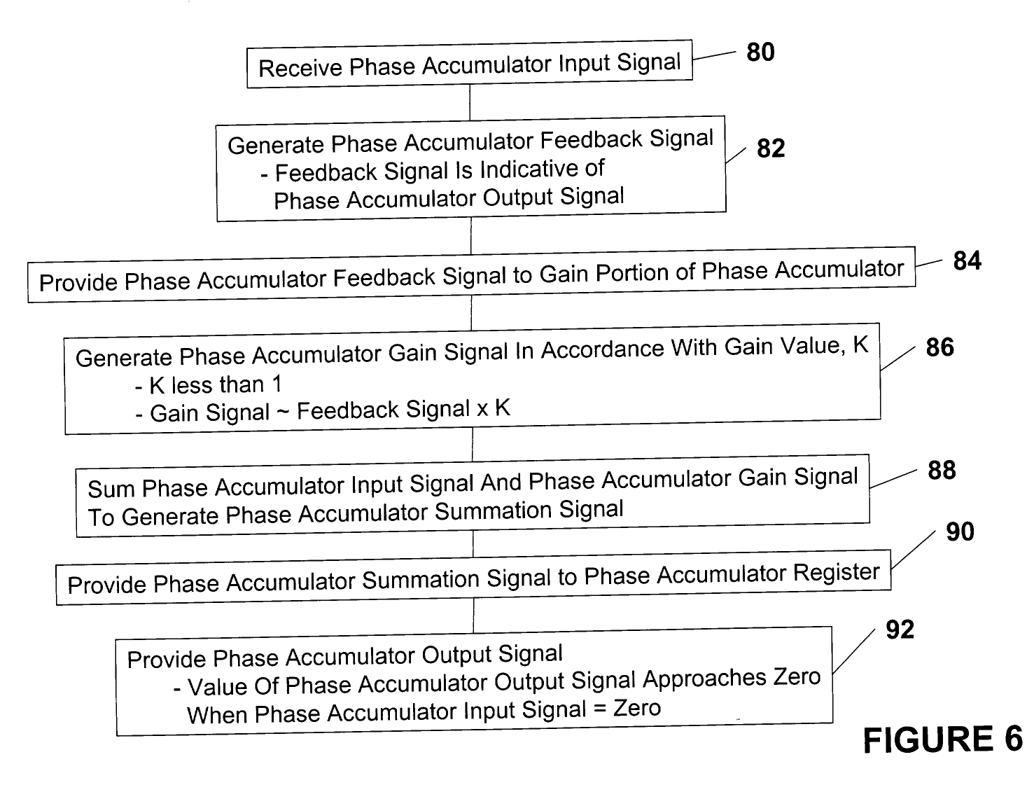

FIG. 6 is a flow diagram of a process for reducing error in a derotator in accordance with an embodiment of the present invention. The following description of the process depicted in FIG. 6 is presented with exemplar references to functions depicted in FIGS. 1, 3, 4, and 5. At step 80, the phase accumulator input signal 34 is received by the phase accumulator 12. The phase accumulator feedback signal 40 is generated at step 82. The phase accumulator feedback signal 40 is indicative of the phase accumulator output signal 38. The phase accumulator feedback signal 40 is provided to the phase accumulator gain portion 46 at step 84. At step 86, the phase accumulator gain signal 48 is generated by the phase accumulator gain portion 46. The phase accumulator gain portion 46 has a gain value, K, less than one (K<1). The phase accumulator gain signal 48 has a value approximately equal to the value of the phase accumulator feedback signal 40 multiplied by the gain value, K. Thus, if Gs is indicative of the value of the phase accumulator gain signal 48, if K is indicative of the gain value, and Fs is indicative of the value of the phase accumulator feedback signal 40, then Gs =K Fs. At step 88, the phase accumulator gain signal 48 and the phase accumulator input signal 34 are summed (added) to generate the phase accumulator summation signal 36. The phase accumulator summation signal 36 is provided to the phase accumulator register 44 at step 90. The summation value is stored in the phase accumulator register 44 and provided via the phase accumulator output signal 38. As described above, when the value of the phase accumulator input signal is equal to zero, even for a very short period of time, the value of the phase accumulator output signal 38 quickly approaches zero, due in part to the gain value, K, being less than one.

A reduced error derotator in accordance with the present invention may be embodied in the form of computer-implemented processes and apparatus for practicing those processes. The reduced error derotator as described herein may also be embodied in the form of computer program code embodied in tangible media, such as floppy diskettes, read only memories (ROMs), CD-ROMs, hard drives, high density disk, or any other computer-readable storage medium, wherein, when the computer program code is loaded into and executed by a computer, the computer becomes an apparatus for practicing the invention. The reduced error derotator as described herein may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

A reduced error derotator in accordance with the present invention provides means for reducing the difference in phase, AO, between various demodulator components and the output signals of the derotator. This eliminates the need for the individual demodulator components to compensate for these various AOs, resulting in demodulators having less complex circuitry, less cost, potential for smaller packaging, and faster response times. This reduced error derotator is applicable to various types of circuits, such as, for example, any M state QAM demodulator (M=4, 8, 16, 32, 64, 128, etc.), any M state PSK demodulator (M=4, 8, 16, 32, 64, 128, etc.), FSK demodulators, and demodulators having other demodulator components (e.g., a slope equalizer, a DC offset compensation circuit, a gain compensations circuit, a clock recovery circuit, an equalizer circuit, or a combination thereof) in various combinations and configurations.

Although illustrated and described herein with reference to certain specific embodiments, the wireless cloning system and method as described herein are nevertheless not intended to be limited to the details shown. Rather, various modifications may be made in the details within the scope and range of equivalents of the claims and without departing from the spirit of the invention.

What is claimed is:

1. A derotator comprising a phase accumulator, wherein:
said phase accumulator is configured to receive an accumulator input signal and provide an accumulator output signal; and
a value of said accumulator output signal approaches zero in response to a value of said accumulator input signal being approximately equal to zero.

2. A derotator in accordance with claim 1, said phase accumulator comprising:
a register configured to provide said accumulator output signal in response to a summation signal;
an adder configured to provide said summation signal in response to an accumulator gain signal and said accumulator input signal; and
a gain portion configured to receive an accumulator feedback signal and provide said accumulator gain signal in response to said accumulator feedback signal, wherein:
said accumulator feedback signal is indicative of said accumulator output signal.

3. A derotator in accordance with claim 2, wherein:
a value of said accumulator gain signal is approximately equal to a product of a gain value and a value of said accumulator feedback signal; and
said gain value is less than one.

4. A derotator in accordance with claim 3, wherein said accumulator gain signal is in accordance with the following equation:
Gs=K Fs, wherein:
Gs is indicative of a value of said accumulator gain signal;
K is indicative of said gain value, being less than one; and
Fs is indicative of a value of said accumulator feedback signal.

5. A demodulator comprising:
a derotator comprising a phase accumulator configured to receive an accumulator input signal and provide an accumulator output signal, wherein:
a value of said accumulator output signal approaches zero in response to a value of said accumulator input signal being approximately equal to zero.

6. A demodulator in accordance with claim 5, said phase accumulator comprising:
a register configured to provide said accumulator output signal in response to a summation signal;
an adder configured to provide said summation signal in response to an accumulator gain signal and said accumulator input signal; and
a gain portion configured to receive an accumulator feedback signal and provide said accumulator gain signal in response to said accumulator feedback signal, wherein:
said accumulator feedback signal is indicative of said accumulator output signal.

7. A demodulator in accordance with claim 6, wherein:
a value of said accumulator gain signal is approximately equal to a product of a gain value and a value of said feedback signal; and
said gain value is less than one.

8. A demodulator in accordance with claim 5, further comprising at least one demodulator component coupled to said derotator, wherein:
each demodulator component receives a respective input signal and provides a respective output signal; and
a relative phase between each of said respective signals and said accumulator output signal approaches zero in response to a value of said accumulator input signal being approximately equal to zero.

9. A demodulator in accordance with claim 8, wherein each of said at least one demodulator component comprises one of an equalizer, a clock recovery portion, a DC offset compensation portion, a slope equalizer, and a gain compensation portion.

10. A method for reducing phase error in a derotator comprising a phase accumulator, said method comprising the steps of:
summing a phase accumulator input signal and a phase accumulator gain signal;
generating a phase accumulator feedback signal indicative of a phase accumulator output signal;
generating said phase accumulator gain signal, wherein:
a value of said phase accumulator gain signal is approximately equal to a product of a gain value and a value of said phase accumulator feedback signal; and
said gain value is less than one; and
providing said phase accumulator output signal, wherein:
a value of said phase accumulator output signal approaches zero in response to a value of said phase accumulator input signal being approximately equal to zero.

11. A method in accordance with claim 10, further comprising:
receiving said phase accumulator input signal;
providing said phase accumulator feedback signal to a gain portion of said phase accumulator; and
providing a phase accumulator summation signal indicative of said summation of said phase accumulator input signal and said phase accumulator gain signal to a phase accumulator register.

12. A method in accordance with claim 10, wherein said phase accumulator gain signal is generated in accordance with the following equation:
Gs=K Fs, wherein:
Gs is indicative of a value of said accumulator gain signal;
K is indicative of said gain value, being less than one; and
Fs is indicative of a value of said accumulator feedback signal.

13. A derotator phase accumulator circuit comprising:
a phase accumulator adder configured to receive a phase accumulator input signal and coupled to a phase accumulator register and a phase accumulator gain portion;
said phase accumulator register configured to provide a phase accumulator output signal and coupled to said phase accumulator adder and said phase accumulator gain portion;
and
said phase accumulator gain portion coupled to said phase accumulator adder and said phase accumulator register, wherein:
a gain value of said phase accumulator gain portion is less than one.

14. A computer readable medium encoded with a computer program code for directing a processor to reduce phase error in a derotator, said program code comprising:
a first code segment for causing said processor to sum a phase accumulator input signal and a phase accumulator gain signal;
a second code segment for causing said processor to generate a phase accumulator feedback signal indicative of a phase accumulator output signal;
a third code segment for causing said processor to generate said phase accumulator gain signal, wherein:
a value of said phase accumulator gain signal is approximately equal to a product of a gain value and a value of said phase accumulator feedback signal; and
said gain value is less than one; and
a fourth code segment for causing said processor to provide said phase accumulator output signal, wherein:
a value of said phase accumulator output signal approaches zero in response to a value of said phase accumulator input signal being approximately equal to zero.

15. A computer readable medium in accordance with claim 14, said program code further comprising:
a fifth code segment for causing said processor to receive said phase accumulator input signal;
a sixth code segment for causing said processor to provide said phase accumulator feedback signal to a gain portion of said phase accumulator; and
a seventh code segment for causing said processor to provide a phase accumulator summation signal indicative of said summation of said phase accumulator input signal and said phase accumulator gain signal to a phase accumulator register.

16. A computer readable medium in accordance with claim 14, wherein said phase accumulator gain signal is generated in accordance with the following equation:
Gs=K Fs, wherein:
Gs is indicative of a value of said accumulator gain signal;
K is indicative of said gain value, being less than one; and
Fs is indicative of a value of said accumulator feedback signal.

17. In a demodulator including a derotator with a feedback loop with a gain portion for multiplying a feedback signal by a predetermined gain value to thereby compensate for phase error of a received signal, the improvement comprising a gain value that is less than one.
